(19) United States
(12) Patent Application Publication
(10) Pub. No.: US 2024/0139839 A1
(43) Pub. Date: May 2, 2024

(54) APPARATUS AND METHOD FOR MACHINING CYLINDRICAL GROOVES BY MULTI-WIRE CUTTING OF PROFILES

(71) Applicants: Shangrao Normal University, Shangrao (CN); Guangzhou dongfuyuan Animal Husbandry Equipment Co., Ltd, Guangzhou (CN)

(72) Inventors: Shengwen YANG, Shangrao (CN); Jinlong LIN, Shangrao (CN); Zhenpin WAN, Shangrao (CN)

(21) Appl. No.: 17/975,886

(22) Filed: Oct. 28, 2022

(51) Int. Cl. B23D 57/00

(52) U.S. Cl. CPC B23D 57/0007

(57) ABSTRACT

Provided are an apparatus and a method for machining cylindrical grooves by multi-wire cutting of profiles, the apparatus includes a driving guide roller and a driven guide roller in a guide roller assembly with axes thereof disposed parallelly and symmetrically, a tension wheel further disposed between the driving guide roller and the driven guide roller, a cutting wire clamped in grooves of the driving guide roller and the driven guide roller and perpendicular to a central axis of a workpiece, and a plurality of segments of the cutting wire forming a cutting wire group mesh surface; and a plurality of grooves are machined simultaneously on the cylindrical surface of the workpiece by the wire group mesh surface, and the cutting wire forms a machining pressure under an action of tension wheel, which can feed smoothly and ensure the accuracy and machining efficiency of the grooves.

### FIELD OF TECHNOLOGY

The present invention relates to the field of cylindrical micro-groove machining, micro-electro-mechanical system modeling and micro-electro-mechanical machining, in particular to an apparatus and a method for machining cylindrical grooves by multi-wire cutting of profiles.

### BACKGROUND

With the rapid development of electronic information technology and photovoltaic industry, the demand for silicon wafers is increasing. In the process of semiconductor wafer production, the silicon crystal bar should be cut into wafers, and the thickness of wafer is usually less than 1 mm. Diamond abrasive wire saw will be used to cut crystal bar, and in sawing, a rubber guide roller with micro-grooves on the surface is adopted to clamp an electroplated abrasive wire, and since there may be hundreds to thousands of micro-grooves on the surface of the guide roller, the micro-grooves on the surface of the rubber guide roller for clamping the electroplated abrasive wire are usually formed by turning with a formed turning tool, and about 3,500 wafers are required to be cut per meter. The tolerance and fit for guide roller are high-precision and expensive CNC (Computer Numerical Control) lathes are needed. At the same time, it takes about 3-5 hours to complete the processing of one guide roller.

On the other hand, the turning tool may not be able to complete the micro-grooves machining of a roller for tool wearing. So, it is necessary to grind the tool in advance. Moreover, the consistency of guide rollers highly relies on a CNC machine.

Therefore, there is an urgent need for a fast, efficient and low-cost method and apparatus for machining micro-grooves of rubber guide rollers, which can realize simultaneous machining of multiple micro-grooves at one time.

### SUMMARY

The purpose of the present invention is to provide an apparatus and a method for machining cylindrical grooves by multi-wire cutting of profiles. Since the cutting wire is involved in the machining of a guide roller, the plane of an annular groove on a cylindrical surface for a driven guide roller is perpendicular to the workpiece axis, by selecting the cross-section shapes of different cutting wires, the corresponding shapes grooves are formed on the workpiece surface, and the multi-wire simultaneous machining of the grooves on the guide roller surface is realized, which improves the machining accuracy and efficiency.

In order to achieve the above purpose, the present invention provides the following technical solution:

An apparatus for machining cylindrical grooves by multi-wire cutting of profiles includes: a guide roller assembly including a driving guide roller and a driven guide roller, wherein axes of the driving guide roller and the driven guide roller are disposed parallel and symmetrically, cylindrical surfaces of the driving guide roller and the driven guide roller are all formed with annular grooves, and the annular grooves on symmetrical positions of the cylindrical surfaces of the driving guide roller and the driven guide roller have the same shape and the same pitch; a multi-wire assembly including at least a releasing roller and a retracting roller; a tension wheel disposed between the driving guide roller and the driven guide roller and having an annular groove disposed on a cylindrical surface thereof; a cutting wire, ends of the cutting wire being wound around the releasing assembly and the retracting assembly respectively, the cutting wire being released from the releasing assembly and sequentially wound in the annular grooves of the driving guide roller, the tension wheel configured to adjust a tension of the cutting wire and the driven guide roller, and retracted in the retracting assembly, wherein the cutting wire forms a wire group mesh surface perpendicular to a central axis of a workpiece between the driving guide roller and the driven guide roller, and the wire group mesh surface is configured to machine a cylindrical groove of the workpiece; and a frame on which the guide roller assembly, the multi-wire assembly and the tension wheel are all disposed and movable connected to the frame.

Further, the frame includes a clamping assembly, a workpiece driver, a fixed claw, a fixed claw coupling, a moving claw and a workpiece moving table assembly; the fixed claw is connected with the workpiece driver through the coupling, the fixed claw clamps one end of the workpiece; the moving claw clamps the other end of the workpiece. The moving claw is movable in an axial direction to adjust to fit the length of workpiece. The workpiece, the fixed claw, the moving claw and the workpiece driver are all disposed on the workpiece moving table assembly.

Further, the workpiece moving table assembly includes a workpiece moving table screw, a moving shaft sleeve, a screw driver and a workpiece table base; the workpiece table base is movably connected with the frame via a guide groove in the side surface of the base, an upper end of workpiece moving table screw is movably connected with the workpiece table base through the moving shaft sleeve, a lower end of the workpiece moving table screw is connected with the output end of the screw driver through a coupling, the screw driver is fixedly connected with the frame, and the fixed claw, the moving claw and the workpiece driver move up and down in the frame along a guide groove with the workpiece table base.

Further, the driving guide roller assembly includes a driving guide roller driver and a driving guide roller coupling, one end of the driving guide roller is installed on the frame through a bearing and a bearing end cap, the other end of the driving guide roller is connected to an output end of the driving guide roller driver through the driving guide roller coupling, the driving guide roller driver drives the driving guide roller to rotate and drives the cutting wire to move directionally through the driving guide roller coupling; and the driven guide roller assembly further includes a driven guide roller bearing and a driven guide roller bearing end cap, an outer surface of a shaft body of the driven guide roller is provided with a groove with a same shape corresponding to an outer surface of a shaft body of the driving guide roller, both ends of the driven guide roller are installed on the frame through the driven guide roller bearing and the driven guide roller bearing end cap.

Further, the releasing roller includes a releasing driver, a releasing shaft coupling and a releasing shaft, an outer surface of a shaft body of the releasing shaft is wound with the cutting wire, and one end of the releasing shaft is connected with the releasing driver through the releasing shaft coupling; the retracting roller includes a retracting driver, a retracting shaft coupling, a retracting shaft, a retracting shaft bearing and a retracting shaft bearing end cap; and an outer surface of a shaft body of the retracting shaft is wound with the cutting wire, one end of the retracting shaft is connected with the retracting driver through the retracting shaft coupling, and the other end of the retracting shaft is connected with the retracting shaft bearing end cap through the retracting shaft bearing.

Further, the frame further includes a first wedge block and a second wedge block for adjusting a height of the tension wheel; and the first wedge block and the second wedge block are respectively installed on an upper side and a lower side of the frame where an end head of each tension wheel is located, and the first wedge block and the second wedge block are installed in opposite directions.

Further, the cutting wire includes a wire body and abrasive particles bonded to the wire body.

Further, a cross-section shape of the cutting wire is consistent with a cross-section shape of a groove machined by the workpiece.

Further, a material of the wire body is metal wire or carbon fiber, and a material of the abrasive particle is diamond or silicon carbide.

Further, a bonding mode of the abrasive particles and the wire body is electroplating, organic bonding or vapor deposition.

Further, the cross-section shape of the cutting wire is trapezoidal, V-shaped, U-shaped, circular or rectangular.

The present invention also discloses a method for machining cylindrical grooves by multi-wire cutting of profiles, which includes the following steps:

S1. positioning and aligning a workpiece and a cutting wire and presetting a benchmark
assembling the workpiece on a clamping assembly, the cutting wire is sequentially wound in annular grooves of a driving guide roller, a tension wheel and a driven guide roller, the cutting wire forming a parallel wire group mesh surface between the driving guide roller and the driven guide roller, wherein each cutting wire forming the wire group mesh surface is perpendicular to a central axis of the workpiece;

S2. adjusting a pressure of the cutting wire
by adjusting a first wedge block and a second wedge block disposed on the frame, a position of a tension wheel moving up and down to change distances between the tension wheel and the driving guide roller and between the tension wheel and the driven guide roller to become larger or smaller, so as to realize a fine adjustment of tensioning or relaxing the cutting wire and further adjust the pressure of the cutting wire on a surface of a workpiece to be machined;

S3. machining a groove of the workpiece by the cutting wire
starting the driver, and a relative movement of the cutting wire realizing the machining of the groove of the workpiece; wherein a workpiece driver and a screw driver respectively drive a rotating movement and up-and-down movement of the workpiece; and the driving guide roller driver drives the driving guide roller to rotate, a releasing driver and a retracting driver are configured to drive a releasing wheel and a retracting wheel to rotate, so as to realize releasing and retracting of the cutting wire, the driven guide roller and the tension wheel are driven to rotate through a movement of the cutting wire and a rotation transmission of the driving guide roller, and a cutting wire speed is 0.1 m/s to 30 m/s.

Further, in the S3, in order to prevent overheating in a groove machining process, a coolant is introduced into a machining area of the workpiece, and a flow rate of the coolant is 1 L/min to 10 L/min.

Further, in the S3, the coolant is an oil-based coolant or a water-based coolant.

Further, in the S3, an antioxidant is added to the water-based coolant, and a mass concentration of the antioxidant is 2% to 5%.

Further, in the S3, when the coolant is used, the coolant circulating system further includes a peristaltic pump, and the coolant circulating system is used for circulating the coolant.

Further, in the S3, the coolant circulation system further includes a filter for filtering particles such as abrasive particles and chips falling from the cutting wire, so as to prevent particles from entering the coolant circulation system and thus entering the machining area of the workpiece.

Further, in the S3, the filter further includes a filter element capable of filtering particles with a diameter of 1 μm to 10 μm.

Further, in the S1, a spacing of arrangement of the cutting wire is consistent with a spacing of the grooves of the workpiece to be machined; the wire group mesh surface is fine-tuned by spatial positions of the driving guide roller and the driven guide roller, to realize an inclination of the wire group mesh surface in a vertical direction of 5° to 15°.

Further, the number of the tension wheels is 1 to 2.

The present invention provides an apparatus and a method for machining cylindrical grooves by multi-wire cutting of profiles, the machined mesh surface is horizontally arranged for the workpiece, a multi-wire simultaneous groove cutting of the cylindrical groove is realized, and multi-groove machining is completed at one time. The cutting wire can form a machining pressure on the surface of workpiece due to the tension of the tension wheel, which can feed more smoothly, ensure the consistency and machining efficiency of each groove, realize stable sawing and improve the machining quality of the groove.

With the apparatus for machining cylindrical grooves by multi-wire cutting of profiles provided by the present invention, the drivers are adjusted at the same time during the machining process, the cutting wire moves directionally and relative to the surface of the workpiece. According to the different shape of the cutting wire, various groove profiles can be machined, the cutting wire is a single wire, which is wound repeatedly for many times to form a machined mesh, the tension of the tension wheel on the cutting wire ensures the consistency of the spacing, depth and shape of the machining grooves.

The present invention provides an apparatus and a method for machining cylindrical grooves by multi-wire cutting of profile, and additionally provides a coolant circulation system for preventing overheating deformation of the workpieces, which ensures that the workpiece will not be deformed due to frictional heat generated by the cutting wire in the process of machining grooves. With apparatus and method for machining cylindrical grooves by multi-wire cutting of profiles, a filter is disposed to collect particles such as abrasive particles and chips falling from the cutting wire, so as to prevent the particles from falling into a coolant circulation system, and prevent the fallen abrasive particles or chips from entering the machining area and causing workpiece damage.

### BRIEF DESCRIPTION OF THE DRAWINGS

The accompanying drawings, forming part of the present application, serve to provide a further understanding of the present invention, and the exemplary embodiments of the present invention, as well as the illustrations thereof, serve to explain the present invention and do not constitute an undue limitation of the present invention. In the drawings:

FIG. 1 is a top view of a structure of an apparatus for machining cylindrical grooves by multi-wire cutting of profiles of the present invention;

FIG. 2 is a front view of the structure of the apparatus for machining cylindrical grooves by multi-wire cutting of the profiles of the present invention;

FIG. 3 is a left view of the structure of the apparatus for machining cylindrical grooves by multi-wire cutting of the profiles of the present invention;

FIG. 4 is a structural diagram of a driving guide roller, a driven guide roller and a tension wheel from top to bottom;

FIG. 5 is an installation structure diagram of the tension wheel and a frame of the present invention;

FIG. 6 is a schematic diagram of cooling the workpiece by a coolant of the present invention;

FIG. 7 is a cutting state diagram of a machined workpiece when a profile of a cutting wire of the present invention is trapezoidal;

FIG. 8 is a cutting state diagram of the machined workpiece when the profile of the cutting wire of the present invention is V-shaped;

FIG. 9 is a cutting state diagram of the machined workpiece when the profile of the cutting wire of the present invention is U-shaped;

FIG. 10 is a cutting state diagram of the machined workpiece when the profile of the cutting wire of the present invention is rectangular;

FIG. 11 is a cutting state diagram of the machined workpiece when the profile of the cutting wire of the present invention is circular;

FIG. 12 is a structural diagram of the cutting wire wound around the driving guide roller, the tension wheel and the driven guide roller in sequence of the present invention; and

FIG. 13 is a structural diagram of a winding mode of the driving guide roller and the driven guide roller of the present invention;

in the drawings:
1—workpiece;
2—clamping assembly; 21—workpiece driver; 22—fixed claw; 23—claw coupling; 24—workpiece bearing end cap; 25—workpiece moving table assembly; 251—workpiece moving table screw; 252—moving shaft sleeve; 253—screw driver; 254—workpiece table base; 26—moving claw;
3—guide roller assembly; 31—driving guide roller assembly; 311—driving guide roller driver; 312—driving guide roller coupling; 313—driving guide roller; 32—driven guide roller assembly; 321—driven guide roller; 322—driven guide roller bearing, 323—driven guide roller bearing end cap;
4—multi-wire assembly; 41—releasing roller, 411—releasing driver; 412—retracting shaft coupling; 413—releasing shaft; 42—retracting roller; 421—retracting driver. 422—releasing coupling; 423—releasing shaft; 424—releasing bearing, 425—releasing bearing end cap;
5—tension wheel; 51—first wedge block; 52—second wedge block;
6—cutting wire; 61—wire body; 62—abrasive particle;
7—frame;
8—coolant.

### DETAILED DESCRIPTION OF THE EMBODIMENTS

The present invention will be described in detail below with reference to the accompanying drawings and in conjunction with embodiments. The various examples are provided by way of interpretation of the present invention and not limiting the present invention. Indeed, it will be apparent to those skilled in the art that modifications and variations may be made in the present invention without departing from the scope or spirit of the present invention. For example, features shown or described as part of one embodiment may be used in another embodiment to produce yet another embodiment. It is therefore desirable that the present invention encompass such modifications and variations falling within the scope of the appended claims and their equivalents.

In the description of the present invention, the terms “longitudinal”, “transverse”, “up”, “down”, “front”, “back”, “left”, “right”, “vertical”, “horizontal”, “top”, “bottom” and the like denote orientation or positional relationships based on those shown in the drawings and are intended for ease of description only and not to require that the present invention must be constructed and operated in a particular orientation and therefore cannot be construed as limiting to the present invention. The terms “joint”, “connect” and “set” used in the present invention should be understood in a broad sense, for example, may be a fixed connection or a detachable connection; it can be directly connection or indirectly connection through intermediate components; and it may be a wired electrical connection, a radio connection, or a wireless communication signal connection, and the specific meanings of the above terms may be understood by those of ordinary skill in the art according to a specific situation.

One or more examples of the present invention are shown in the accompanying drawings. The detailed description uses numeric and alphabetic markers to refer to features in the drawings. Similar or like reference signs in the drawings and descriptions have been used to refer to similar or like parts of the present invention. As used herein, the terms “first”, “second” and “third” and the like are used interchangeably to distinguish one member from another and are not intended to denote the location or importance of individual members.

### Embodiment 1

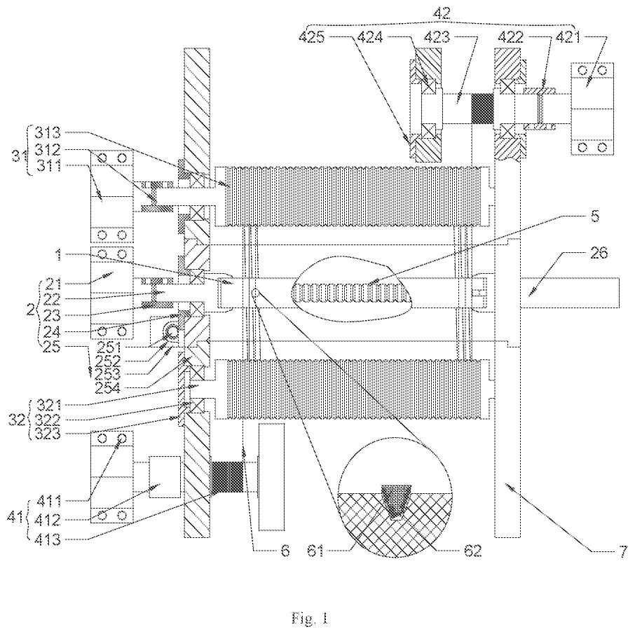

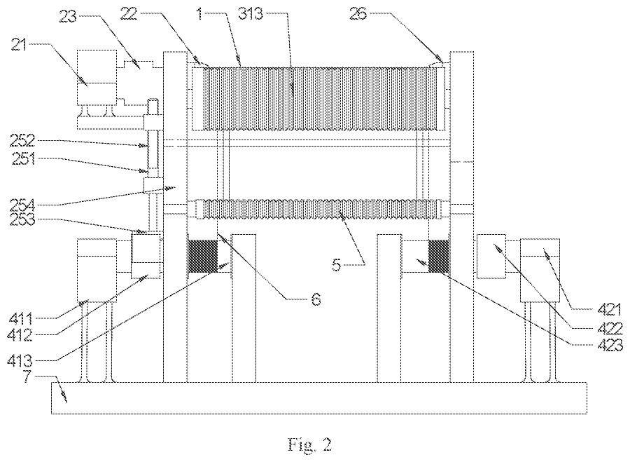

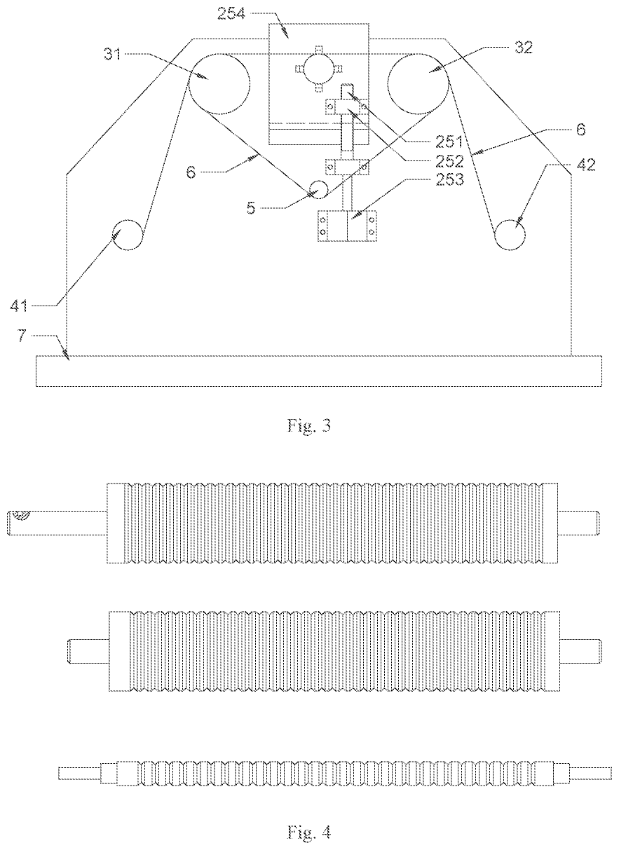

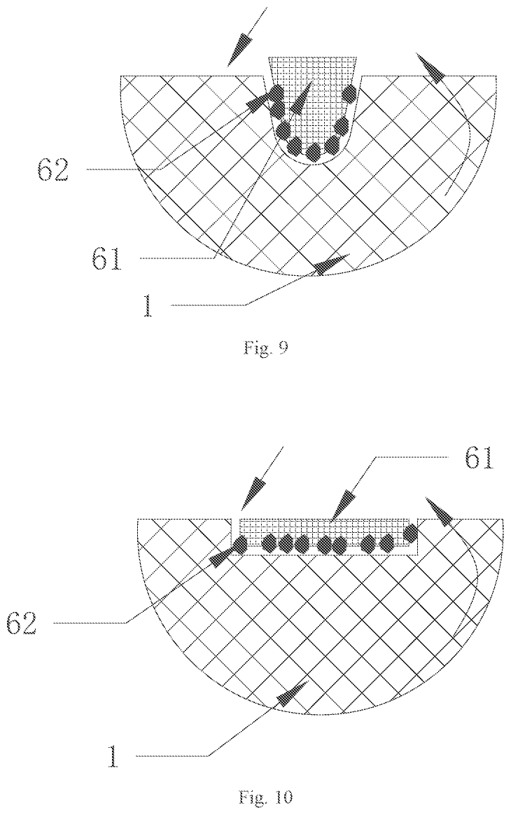

As shown in FIGS. 1 to 11, according to an embodiment of the present invention, the present invention provides an apparatus for machining cylindrical grooves by multi-wire cutting of profiles, which includes a frame 7, a clamping assembly 2, a guide roller assembly 3, a multi-wire assembly 4 and a cutting wire 6, the guide roller assembly 3 includes a driving guide roller assembly 31 and a driven guide roller assembly 32, the driving guide roller assembly 31 includes a driving guide roller driver 311, a driving guide roller coupling 312 and a driving guide roller 313, and the driven guide roller assembly 32 includes a driven guide roller 321, a driven guide roller bearing 322 and a driven guide roller bearing end cap 323. The guide roller assembly is used for arranging, clamping and driving the cutting wire 6 to ensure that a spacing of the cutting wires is consistent with a pitch of the driven guide roller 321 and the driving guide roller 313 and the movement is stable. The driving guide roller 313 and the driven guide roller 321 are arranged in parallel with each other on the frame; when axes of the driving guide roller 313 and the driven guide roller 321 disposed parallely are perpendicular to the cutting wire 6, the cutting wire 6 has a short cutting contact with the workpiece 1, an accurate cutting of the shape and size of the groove is still maintained, and the position accuracy of the machining groove and the workpiece axis is ensured. The multi-wire assembly 4 includes a releasing roller 41 and a retracting roller 42, and both ends of the cutting wire 6 are respectively wound around the releasing roller 41 and the retracting roller 42; a tension wheel 5 parallel to the driving guide roller 313 or the driven guide roller 321 is also disposed between the driving guide roller 313 and the driven guide roller 321 for adjusting a tension of the cutting wire 6; the tension wheel 5 is used for adjusting a tensioning pressure between the driving guide roller 313 and the driven guide roller 321 while preventing the cutting wire 6 from deflecting due to the excessive length of the cutting wire 6; as shown in FIG. 11, annular grooves are provided on outer surfaces of a shaft body of the driving guide roller 313, the driven guide roller 321 and the tension wheel 5; the annular grooves on a cylindrical surface of the driving guide roller 313 and a cylindrical surface of the driven guide roller 321 at corresponding positions have the same shape and the same pitch; and thus, the shape and pitch of the annular grooves at the corresponding positions of the workpiece and the cylindrical surface of the driving guide roller 313 or the driven guide roller 321 are ensured to be consistent, so that the groove profile of the driving guide roller 313 or the driven guide roller 321 is simulated on the cylindrical surface of the workpiece.

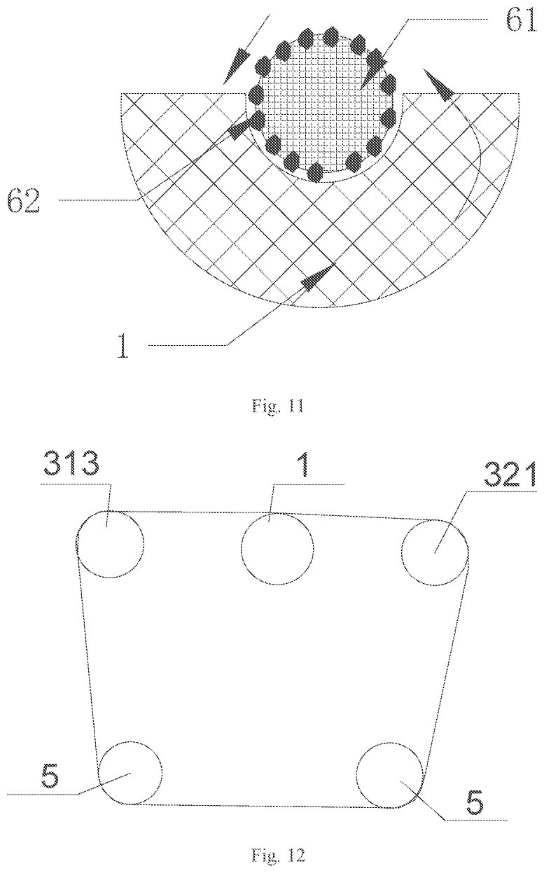

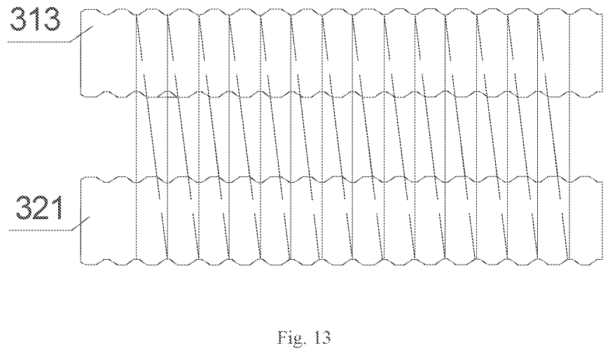

As shown in FIGS. 12-13, the cutting wire 6 is released from the releasing roller 41 and repeatedly wound in the annular grooves of the driving guide roller 313, the tension wheel 5 and the driven guide roller 321, the cutting wire 6 is finally retracted from the driven guide roller 321 to the retracting roller 42, and the clamping assembly 2, the guide roller assembly 3 and the tension wheel 5 are respectively movably connected with the frame 7. The clamping assembly 2 is used for clamping the workpiece 1. The cutting wire 6 forms a wire group mesh surface perpendicular to a central axis of the workpiece 1 between the driving guide roller 313 and the driven guide roller 321 for machining the groove on the outer surface of the workpiece. The machined mesh surface is horizontally arranged for the workpiece, a multi-wire simultaneous groove cutting of the cylindrical groove is realized, and multi-groove machining is completed at one time. The cutting wire can form a machining pressure on the surface of workpiece due to the tension of the tension wheel, which can feed more smoothly, ensure the consistency and machining efficiency of each groove, realize stable molding and improve the machining quality of groove.

As shown in FIGS. 1-3, the clamping assembly 2 includes a fixed claw 22, a claw coupling 23, a moving claw 26, a workpiece driver 21 and a workpiece moving table assembly 25. One end of the fixed claw 22 clamps the workpiece 1, the other end of the fixed claw 22 is connected with an output end of the workpiece driver 21 through the claw coupling 23, and the workpiece driver 21 drives the rotating movement of the workpiece 1 through the claw coupling 23; and One end of the moving claw 26 clamps the workpiece 1. Both the fixed claw 22 and the moving claw 26 can move along a radial direction of the workpiece 1 to adjust the position of the workpiece and clamp the workpiece. The moving claw 26 can adjust and clamp the workpiece at any time according to the different axial length of the workpiece. The fixed claw 22, the moving claw 26 and the workpiece 1 are disposed on the workpiece moving table assembly 25 for driving the workpiece 1 to move up and down.

The workpiece moving table assembly 25 includes a moving table screw 251, a moving shaft sleeve 252, a screw driver 253, and a workpiece table base 254, a guide groove is provided on a side surface of the workpiece table base 254, the workpiece table base 254 is mounted on the frame 7, the fixed claw 22, the moving claw 26 and the workpiece 1 are all mounted on the workpiece stage base 254. The fixed claw 22, the moving claw 26 and the workpiece 1 can move up and down along with the guide groove along the workpiece table base 254 in the frame 7. One end of the workpiece moving table screw 251 is connected to the workpiece table base 254 through the moving shaft sleeve 252, the other end of the workpiece stage base 254 is connected to the frame 7 through a shaft sleeve, a distal end of the workpiece stage base 254 is connected to the output end of the screw driver 253 through a coupling, and the screw driver 253 is fixedly connected to the frame 7. The screw driver 253 is started to drive the workpiece moving table screw 251 to rotate, and the screw groove in the moving shaft sleeve 252 is fitted with the workpiece moving table screw 251. When the workpiece moving table screw 251 rotates, the moving shaft sleeve 252 can move up and down along the workpiece moving table screw 251 axially, thereby driving the workpiece table base 254 and the workpiece on the clamping assembly 2 to move up and down.

The driving guide roller assembly 31 further includes a driving guide roller driver 311, a driving guide roller coupling 312, an annular groove on an outer surface of the driving guide roller 313 is used for driving and arranging a cutting wire 6, the driving guide roller 313 is mounted on a frame 7 through a bearing and the bearing end cap, one end of the driving guide roller 313 is connected to the output end of the driving guide roller driver 311 through the driving guide roller coupling 312, and the driving guide roller coupling 312 and the driving guide roller 313 are driven to rotate simultaneously by the driving guide roller driver 311, thus driving the cutting wire 6 to move; the driven guide roller assembly 32 further includes a driven guide roller bearing 322 and a driven guide roller bearing end cap 323, an outer surface of a shaft body of the driven guide roller 321 and an outer surface of a shaft body of the driving guide roller 313 have grooves with the same pitches at corresponding positions, and the shape and arrangement rule of the grooves are precisely reproduced on the surface of the workpiece during the cutting process of the profile cutting wire; and both ends of the driven guide roller 321 are mounted on the frame 7 through the driven guide roller bearing 322 and the driven guide roller bearing end cap 323.

The releasing roller 41 includes a releasing driver 411, a releasing shaft coupling 412, and a releasing shaft 413, an outer surface of the releasing shaft 413 is wound with the cutting wire 6, and one end of the releasing shaft 413 is connected to the releasing driver 411 through the releasing shaft coupling 412; the releasing driver 411 is started to drive the releasing shaft 413, so that the cutting wire 6 is released from the releasing shaft 413, enters the annular groove on the outer surface of the shaft body of the driving guide roller 313, and makes directional movement. The retracting roller 42 includes a retracting driver 421, a retracting shaft coupling 422, a retracting shaft 423, a retracting shaft bearing 424 and a retracting shaft bearing end cap 425; an outer surface of the retracting shaft 423 is wound with the cutting wire 6, and one end of the retracting shaft 423 is connected to the retracting driver 421 through the retracting shaft coupling 422; and the retracting driver 421 is started, and the retracting driver 421 is driven with the retracting shaft 423, so that the cutting wire 6 is retracted into the retracting shaft 413 from the driven guide roller 321, and the other end of the retracting shaft 423 is connected to the retracting shaft bearing end cap 425 through the retracting shaft bearing 424. The releasing roller 41 and the retracting roller 42 are used for retracting and releasing of the cutting wire 6 so that the cutting wire 6 which is not involved in the machining and which have been machined are arranged neatly and do not interfere with each other. It should be noted that when the cutting wire 6 wound around the outer surface of the releasing shaft 413 is about to be exhausted, at this time, most of the cutting wire 6 is wound around the outer surface of the shaft body of the retracting shaft 423, making all the drivers move in reverse, the functions of the releasing roller 41 and the retracting roller 42 are exchanged, that is, the releasing shaft 413 retracts the cutting wire 6, and the retracting shaft 423 releases the cutting wire 6. In order to ensure the uniform tension of the cutting wire 6, the rotation of all the rotary moving parts should be synchronized.

The cutting wire 6 is released from the releasing roller 41 and is repeatedly wound in the annular grooves of the driving guide roller 313, the tension wheel 5, and the driven guide roller 321, the driving guide roller driver 311 is started, and the driving guide roller driver 311 drives the driving guide roller 313 to rotate, and at the same time, the releasing driver 411 and the retracting driver 421 are started so that the cutting wire 6 makes directional movement, and the cutting wire 6 also surrounds the outer surface of the driven guide roller 321, and the directional movement of the cutting wire 6 drives the driven guide roller 321 to rotate. The cutting wire 6 moves horizontally relative to the workpiece surface under an action of a guide roller assembly 3, but its whole body is spirally advanced, and the surface of the cutting wire 6 is bonded with abrasive particles 62. In order to reduce the wear of the cutting wire to the grooves on the surfaces of the driving guide roller 313 and the driven guide roller 321, the guide roller material can be made of cemented carbide with higher hardness. A cross-section shape of the wire body 61 of the cutting wire 6 is the same with a cross-section shape of the workpiece 1 and the groove profile to be machined. The abrasive particles 62 are bonded to a lower surface of the wire body 61, and impurities on surface of the workpiece 1 after machining the groove are removed by the movement of the cutting wire 6 relative to the surface of the workpiece 1.

The cutting wire 6 has a longer intermediate span from the releasing roller 41 to the retracting roller 42, an axial runout is easy to occur, in order to reduce the axial runout of the cutting wire 6, improve the consistency of the spacing of the annular grooves, and at the same time make the cutting wire 6 have a larger wrap angle on the surface of the workpiece 1, a tension wheel 5 parallel to the driving guide roller 313 or the driven guide roller 321 is also disposed between the driving guide roller 313 and the driven guide roller 321 for arranging the cutting wire 6 and adjusting a surface pressure of the cutting wire 6 on the workpiece 1. The outer surface of the tension wheel 5 is provided with annular grooves having the same pitch as that on the surfaces of the driving guide roller 313 and the driven guide roller 321. In order to ensure that the grooves on surface of the machined workpiece have the same spacing, the cutting wire 6 arranged parallelly are perpendicular to the central axis of the workpiece 1. Both ends of the tension wheel 5 are mounted on the frame 7, and the pressure of the cutting wire 6 on the surface of the workpiece 1 is adjusted by adjusting an axis height of the tension wheel 5. As shown in FIG. 5, the two ends of the tension wheel 5 are respectively mounted on the frame 7, and heights of the two ends of the tension wheel 5 are adjusted by a first wedge block 51 and a second wedge block 52. The fixing mode of the height adjustment of the two ends of the tension wheel 5 on the frame is not limited to the above-mentioned mode, and the structure that can realize the adjustable center height of the tension wheel is within this protection range.

The length of the integral wire body 61 of the cutting wire 6 is longer, one end of the cutting wire 6 is fixed to the releasing shaft 413, and most of the cutting wire 6 is wound on the releasing shaft 413, the other end is sequentially wound in annular grooves on outer surfaces of the driving guide roller 313, a first tension wheel 51, the driven guide roller 321, and a second tension wheel 52 and arranged evenly and alternately, the cutting wire 6 forms a parallel wire group mesh surface of the groove on the outer surface of the workpiece 1 perpendicular to the central axis of the workpiece 1 between the driving guide roller 313 and the driven guide roller 321, and finally the other end of the cutting wire 6 is retracted and fixed to the retracting shaft 433.

Each structural part driven cooperatively by the workpiece driver 21, the driving guide roller driver 311, the screw driver 253, the releasing driver 411 and the retracting driver 421 on the frame 7 is started, the cutting wire 6 is released from the releasing shaft 413, driven by the driving guide roller driver 311, the cutting wire 6 moves directionally from the driving guide roller 313 to the driven guide roller 321, at the same time, the workpiece driver 21 and the screw driver 253 push the workpiece 1 toward the parallel wire group mesh surface formed by the cutting wire 6 between the driving guide roller 313 and the driven guide roller 321 to perform groove machining. During machining, the cutting wire 6 is gradually retracted into the retracting shaft 423. With the extension of machining time, the cutting wire 6 on the releasing shaft 413 is gradually reduced, and the cutting wire 6 on the retracting shaft 423 is gradually increased, and when the cutting wire 6 on the releasing shaft 413 is about to be exhausted, all the drivers are driven in reverse direction. At this time, the releasing and retracting of the releasing roller 41 and the retracting roller 42 are reversed, to ensure the uniform tension of each cutting wire 6, the transmission of each rotary moving part should be kept synchronized.

The clamping assembly 2, the guide roller assembly 3 and the multi-wire assembly 4 are all mounted on the frame 7. The clamping assembly 2, the guide roller assembly 3 and the multi-wire assembly 4 can be rotated and connected with the frame through bearings and bearing end caps, or other connection modes can be adopted as long as the above movements can be realized.

The frame 7 is further provided with the first wedge block 51 and the second wedge block 52 for adjusting the height of the tension wheel 5. The first wedge block 51 and the second wedge block 52 are respectively installed on an upper side and a lower side of the frame 7 where an end head of each tension wheel 5 is located, and the first wedge block 51 and the second wedge block 52 are installed in opposite directions, thereby realizing the adjustment of the surface pressure of the cutting wire.

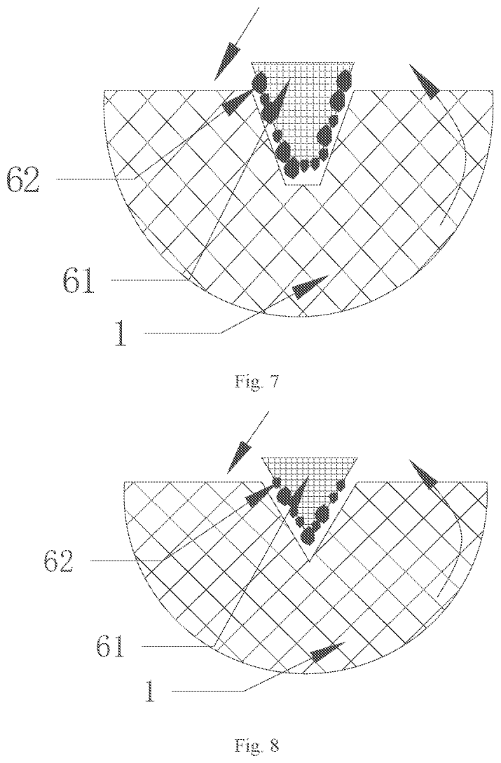

As shown in FIGS. 7 to 10, the cutting wire 6 includes a wire body 61 and abrasive particles 62 bonded to the wire body 61. A material of the wire body 61 is metal wire or carbon fiber, a material of the abrasive particle 62 is diamond or silicon carbide; a bonding mode of the abrasive particles 62 and the wire body 61 is electroplating, organic bonding or vapor deposition; and a cross-section shape of the cutting wire 6 is trapezoidal, V-shaped, U-shaped, circular or rectangular, and the cutting wire 6 has different groove profiles corresponding to the cut workpiece according to the different shapes of the above-mentioned profiles.

### Embodiment 2

As shown in FIGS. 1 to 13, the embodiment also provides a method for machining a groove on a surface of a workpiece shaft with a multi-wire cutting wire of profiles, which includes the following steps:

S1, positioning and aligning the workpiece and the cutting wire and presetting the benchmark, assembling the workpiece on the clamping assembly, a diameter of the selected workpiece being 300 mm, a length of the workpiece being 900 mm, the cutting wire being selected as a cutting wire whose profile is trapezoidal, disposing the tension wheel on the frame, the cutting wire being wound around in the annular grooves of the driving guide roller 313, the driven guide roller 321 and the tension wheel 5 sequentially, and the cutting wire 6 forming a wire group mesh surface between the driving guide roller 313 and the driven guide roller 321, a spacing of the arrangement of the cutting wire being consistent with a spacing of grooves of the workpiece to be machined, and the central axis of the assembled workpiece 1 being perpendicular to the cutting wire 6 of the parallel wire group mesh surface.

S2, adjust the pressure of cutting wire 6, by adjusting the first wedge block 51 and the second wedge block 52 disposed on the frame 7, the position of the tension wheel 5 being moved up and down so that distances between the tension wheel 5 and the driving guide roller 313 or between the tension wheel 5 and the driven guide roller 321 become larger or smaller, the cutting wire 6 being wound in the grooves of the driving guide roller 313, the tension wheel 5 and the driven guide roller 321 sequentially, the tension force of the tension wheel 5 adjusting the pressure of the cutting wire to 150 N to 200 N, the machined profile of the cutting wire 6 being uniformly and symmetrically distributed with 3500 to 4500 diamond particles distributed in every 20 mm length, the tension of the cutting wire being 90 N to 110 N, upper and lower bottom edges of the trapezoidal profile of the cutting wire being 280 μm and 100 μm respectively, a height of the trapezoidal profile of the cutting wire being 200 μm, and an angle between two sides of the machined groove being 38°±10; and a groove depth of the workpiece being 200 μm, a groove depth tolerance being 15 μm, a pitch between a center wires of two adjacent grooves being 267 μm to 272 μm, and a pitch tolerance being 5 μm, which realizes fine adjustment of tightening or relaxing the cutting wire 6, and then adjusts the surface pressure of the cutting wire 6 on the workpiece 1 to be machined.

S3, the cutting wire 6 performing groove machining on the workpiece 1, starting the driver, and the cutting wire 6 performing groove machining on the workpiece 1; wherein a workpiece driver 21 and a screw driver 253 respectively drive a rotating movement and up-and-down movement of the workpiece 1; the driving guide roller driver 311 drives the driving guide roller 313 to rotate, the releasing driver 411 and the retracting driver 421 are used for the releasing and take up of the cutting wire 6, the driving guide roller 313 rotates to drive a relative rotation of the driven guide roller 321 and the tension wheel 5, and a running speed of the cutting wire 6 is from 1 m/s to 15 m/s, for example, 1 m/s, 2 m/s, 5 m/s, 10 m/s, 15 m/s, and an interval segment or an interval point between the running speeds of any two cutting wires; a pitch compensation value is 2 μm to 5 μm depending on the model and a thickness of the load sheet; and requirements of wall edge are no steps, burrs and debris, and the machining efficiency is 30 min/piece.

For the consistency of machining grooves, the profile of the cutting wire 6 should be consistent with the cross-section of the groove profile of the groove to be machined on the surface of the workpiece 1. As shown in FIG. 7, the machined groove profile in the embodiment 1 is a Trapezoidal groove, the wire body 61 is made of metal wire, and the abrasive particles 62 bonded to the outer surface of the cutting wire 6 can be diamond abrasive, a particle size of the abrasive particles 62 is 1 to 10 μm, and the bonding mode between the abrasive material 62 and the wire body 61 is electroplating.

In step S3, each driver is started at the same time, the cutting wire 6 is released from the releasing shaft 313, and the cutting wire 6 moves directionally in a groove formed on the surface in accordance with the outer shape of the cutting wire under the drive of the driving guide roller 313, and the cutting wire 6 processes the axial surface of the workpiece 1. The cutting wire 6 is gradually retracted on the retracting wheel 423. With the extension of processing time, the cutting wire 6 on the releasing shaft 413 is gradually reduced, the cutting wire 6 on the retracting shaft 423 is gradually increased, and when the cutting wire 6 on the releasing shaft 413 is about to be exhausted, all the drivers are driven in reverse direction. At this time, the functions of the releasing roller 41 and the retracting roller 42 are reversed, to ensure the uniform tension of each cutting wire 6, the transmission of each rotary moving part should be synchronized. The wire group mesh surface is fine-tuned by the spatial positions of the driving guide roller and the driven guide roller, and the cutting wire of the wire group mesh surface is offset by 5 to 15 degrees from the middle surface of the wire group mesh surface.

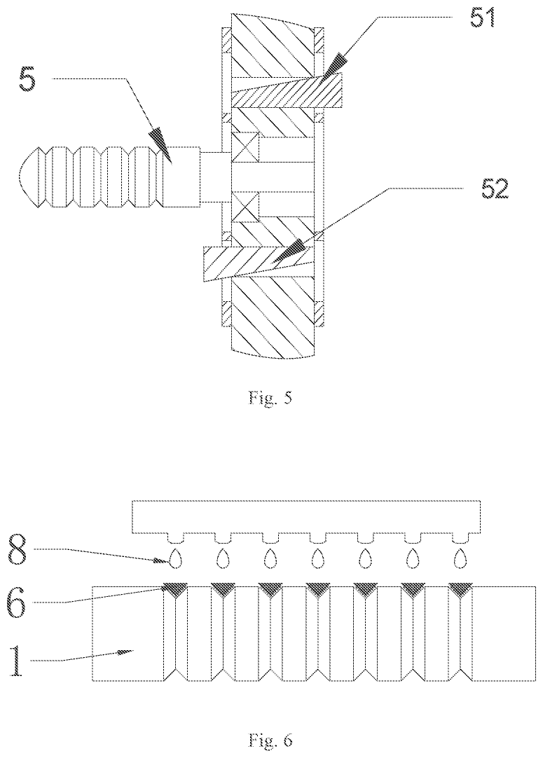

As shown in FIG. 6, during the machining process, a friction between the cutting wire 6 and the surface of the workpiece 1 may generate a large amount of heat, the coolant is used in the machined area of the workpiece. The coolant is used to reduce the temperature of the machined surface and flush the machined surface at the same time. The flow rate of the coolant is 5 L/min to ensure the normal machining of the workpiece. The water-based coolant is selected as the coolant. When the water-based coolant is used, antioxidants can be added, and the mass of antioxidants accounts for 5% of the mass of the water-based coolant, which can prevent the water-based coolant from being oxidized and deteriorated and corroding workpieces and equipment. When the coolant is used, a corresponding coolant circulation system can be selected for the circulation of the coolant. The driver of the circulation system can be a peristaltic pump, which has the advantages of adjustable flow rate, convenient replacement and the like, and can also be driven by other mechanisms as long as the circulation of the coolant can be realized. The coolant circulation system includes a filter for filtering chips produced during machining and abrasive particles 62 fallen from cutting wire 6, so as to prevent abrasive particles 62 from following the coolant into machining area, causing scratches in grooves and affecting surface quality of grooves. The filter can be a common filter element with a filtration diameter of 3 μm or other filters, as long as the above-mentioned coolant can be filtered.

By adopting the method and the apparatus, the guide roller with multiple grooves on the surface can be machined simultaneously with multiple grooves on the surface, the groove machining efficiency is improved, and the consistency of each groove can be well ensured at the same time. An outer surface of a shaft body of the driven guide roller 321 and an outer surface of a shaft body of the driving guide roller 313 have precision machined grooves, according to the different functions of the guide rollers used, the groove shapes of the required guide rollers are also different, in general, it is necessary to rely on high-precision CNC machine tools. When a single groove is machined according to the needs, it is difficult to ensure the required accuracy due to the wear of machining tools. When grooves are distributed in specific requirements, it is very difficult to ensure the accuracy and consistency of machine tools, and the machining cost is high.

By clamping a profile, high-strength electroplated diamond cutting wire into a precision groove of the outer surface of the shaft body of the driven guide roller 321 and a precision groove of the driving guide roller 313, because of the different cross sections of the clamped profile, the groove shape and arrangement rule can be accurately reproduced on the surface of the machined workpiece during the cutting process of the profile cutting wire, which has the advantages of fast machining speed, high machining efficiency, low equipment requirements and greatly reduced cost.

### Embodiments 3 to 6

As shown in FIGS. 8 to 11, the embodiments 3 to 6 provide a method for machining a groove on a surface of a workpiece shaft with a multi-wire cutting wire of profiles, the profile of the cutting wire used is a V-shaped, U-shaped, rectangular and circular machined workpiece. The machining steps are the same as those of embodiment 1, and each machining parameter of the embodiments 3 to 6 is shown in Table 1.

The profile of the cutting wire of the embodiment 3 is V-shaped, the upper bottom edge is 200 μm, the height is 280 μm, and the angle between the two sides is 38°±1°. The groove depth of the machined workpiece is 280 μm, the groove depth tolerance is +15 μm, the pitch between the center wires of two adjacent grooves is 267 μm to 272 μm, the pitch tolerance is ±5 μm, and the machining efficiency is 25 min/piece.

The profile of the cutting wire of the embodiment 4 is U-shaped, and a bottom angle between the two sides of the machined groove is about 60°±1°. The groove depth of the machined workpiece is 280 μm, the groove depth tolerance is ±10 μm, the pitch between the center wires of two adjacent grooves is 267 μm to 272 μm, the pitch tolerance is +3 μm, and the machining efficiency is 35 min/piece.

The profile of the cutting wire of the embodiment 5 is rectangular, and the cross-section size is about 100 μm*280 μm. The groove depth of the machined workpiece is 260 μm, the groove depth tolerance is ±10 μm, the pitch between the center wires of two adjacent grooves is 267 μm to 272 μm, the pitch tolerance is +5 μm, and the machining efficiency is 20 min/piece.

A diameter of the cutting wire of the embodiment 6 is 150 μm, and the profile of the cutting wire is circular, The groove depth of the machined workpiece is 320 μm, the groove depth tolerance is ±5 μm, the pitch between the center wires of two adjacent grooves is 267 μm to 272 μm, the pitch tolerance is +5 μm, and the machining efficiency is 20 min/piece.

The machining parameters of the embodiments 3 to 6 are shown in Table 1.

TABLE 1
corresponding parameters of each step in the method for machining cylindrical
grooves by multi-wire cutting of profiles in embodiments 2 to 6

| Step parameter | Embodiment 2 | Embodiment 3 | Embodiment 4 | Embodiment 5 | Embodiment 6 |
|---|---|---|---|---|---|
| Workpiece diameter (mm) | 300 | 350 | 500 | 400 | 500 |
| Workpiece length (mm) | 900 | 1050 | 900 | 1000 | 1050 |
| Number of tension wheels | 1 | 2 | 1 | 1 | 2 |
| (pieces) | | | | | |
| Tension of cutting wire (N) | 90-110N | 80-100N | 100-110N | 150-500N | 200-500N |
| Material of wire body of | Metal wire | Metal wire | Metal wire | Carbon fiber | Carbon fiber |
| cutting wire | | | | | |
| Material of abrasive particles | Diamond | Diamond | Silicon carbide | Diamond | Diamond |
| Bonding mode of abrasive | Electroplating | Organic | Vapor | Electroplating | Electroplating |
| particles and wire body | | bonding | deposition | | |
| Cross-section shape of cutting | Trapezoidal | V-shaped | U-shaped | Circular | Rectangular |
| wire | | | | | |
| Number of abrasive particles | 3500-4500 | 4000-5000 | 4500-5500 | 3500-4500 | 3000-4000 |
| (piece) | | | | | |
| Angle between two sides of | 38° ± 1° | 38° ± 1° | 60° ± 1° | 0° | 60° ± 1° |
| machining groove | | | | | |
| Groove depth (μm) | 200 | 280 | 280 | 260 | 320 |
| Groove depth tolerance (μm) | ±10 | ±15 | ±10 | ±10 | ±5 |
| Cutting wire speed (m/s) | 1-15 | 5-20 | 15-20 | 10-25 | 3-30 |
| Range of pitch compensation | ±5 | ±5 | ±3 | ±5 | ±5 |
| (μm) | | | | | |
| Workpiece machining | 30 | 25 | 35 | 20 | 20 |
| efficiency (min/piece) | | | | | |
| Type of coolant | Water-based | Water-based | Oil-based | Oil-based | Oil-based |
| | coolant | coolant | coolant | coolant | coolant |
| Flow rate of coolant (L/min) | 5 L/min | 4 L/min | 1 L/min | 10 L/min | 8 L/min |
| Antioxidant Coolant | 5% | 2% | | 5% | 4% |
| Filtration diameter of filter | 1-10 | 1-10 | 1-10 | 5-9 | 1-10 |
| element (μm) | | | | | |

The above are only preferred embodiments of the present invention and the technical principle used. It will be understood by those skilled in the art that the present invention is not limited to the particular embodiments described herein and that various significant changes, readjustments and substitutions can be made to those skilled in the art without departing from the scope of the present invention. Therefore, although the present invention has been described in more detail by the above embodiments, the present invention is not limited to the above embodiments, but may include more other equivalent embodiments without departing from the inventive concept, and the scope of the present invention is determined by the scope of the appended claims.

What is claimed is:

1. An apparatus for machining cylindrical grooves by multi-wire cutting of profiles, comprising:
a guide roller assembly including a driving guide roller and a driven guide roller, wherein axes of the driving guide roller and the driven guide roller are disposed parallel and symmetrically, cylindrical surfaces of the driving guide roller and the driven guide roller are all formed with annular grooves, and the annular grooves on symmetrical positions of the cylindrical surfaces of the driving guide roller and the driven guide roller have the same shape and the same pitch;
a multi-wire assembly including at least a releasing roller and a retracting roller;
a tension wheel disposed between the driving guide roller and the driven guide roller and having an annular groove disposed on a cylindrical surface thereof;
a cutting wire, ends of the cutting wire being wound around the releasing assembly and the retracting assembly respectively, the cutting wire being released from the releasing assembly and sequentially wound in the annular grooves of the driving guide roller, the tension wheel configured to adjust a tension of the cutting wire and the driven guide roller, and retracted in the retracting assembly, wherein the cutting wire forms a wire group mesh surface perpendicular to a central axis of a workpiece between the driving guide roller and the driven guide roller, and the wire group mesh surface is configured to machine a cylindrical groove of the workpiece; and
a frame on which the guide roller assembly, the multi-wire assembly and the tension wheel are all disposed and movable connected to the frame.

2. The apparatus for machining cylindrical grooves by multi-wire cutting of profiles according to claim 1, wherein the frame further comprises a clamping assembly comprising a fixed claw, a claw coupling, a moving claw, a workpiece driver and a workpiece moving table assembly,
the fixed claw clamps one end of the workpiece, the fixed claw is fixedly connected with an output end of the workpiece driver through the claw coupling, and the workpiece driver drives the workpiece to rotate through the claw coupling; and
the moving claw clamps the other end of the workpiece, and the moving claw is movable in an axial direction of the workpiece to adjust a position of clamping the workpiece, and the fixed claw, the moving claw and the workpiece driver are all disposed on the workpiece moving table assembly.

3. The apparatus for machining cylindrical grooves by multi-wire cutting of profiles according to claim 2, wherein the workpiece moving table assembly comprises a workpiece moving table screw, a moving shaft sleeve, a screw driver and a workpiece table base;
a side surface of the workpiece table base comprises a guide groove, the workpiece table base is movably connected with the frame, an upper end of the workpiece moving table screw is movably connected with the workpiece table base through the moving shaft sleeve, a lower end of the workpiece moving table screw is connected with the frame through a shaft sleeve, a lower end of the workpiece moving table screw is connected with an output end of the screw driver through a coupling, the screw driver is fixedly connected with the frame, and the fixed claw, the moving claw and the workpiece driver move up and down in the frame along a guide groove with the workpiece table base.

4. The apparatus for machining cylindrical grooves by multi-wire cutting of profiles according to claim 3, wherein the driving guide roller assembly further comprises a driving guide roller driver and a driving guide roller coupling, one end of the driving guide roller is installed on the frame through a bearing and a bearing end cap, the other end of the driving guide roller is connected to an output end of the driving guide roller driver through the driving guide roller coupling, the driving guide roller driver drives the driving guide roller to rotate and drives the cutting wire to move directionally through the driving guide roller coupling; and
the driven guide roller assembly further comprises a driven guide roller bearing and a driven guide roller bearing end cap, an outer surface of a shaft body of the driven guide roller is provided with a groove with a same shape corresponding to an outer surface of a shaft body of the driving guide roller, both ends of the driven guide roller are installed on the frame through the driven guide roller bearing and the driven guide roller bearing end cap.

5. The apparatus for machining cylindrical grooves by multi-wire cutting of profiles according to claim 4, wherein the releasing roller comprises a releasing driver, a releasing shaft coupling and a releasing shaft, an outer surface of a shaft body surface of the releasing shaft is wound with the cutting wire, and one end of the releasing shaft is connected with the releasing driver through the releasing shaft coupling,
the retracting roller comprises a retracting driver, a retracting shaft coupling, a retracting shaft, a retracting shaft bearing and a retracting shaft bearing end cap; and an outer surface of a shaft body of the retracting shaft is wound with the cutting wire, one end of the retracting shaft is connected with the retracting driver through the retracting shaft coupling, and the other end of the retracting shaft is connected with the retracting shaft bearing end cap through the retracting shaft bearing.

6. The apparatus for machining cylindrical grooves by multi-wire cutting of profiles according to claim 5, wherein the frame further comprises a first wedge block and a second wedge block for adjusting a height of the tension wheel; and
the first wedge block and the second wedge block are respectively installed on an upper side and a lower side of the frame where an end head of each tension wheel is located, and the first wedge block and the second wedge block are installed in opposite directions.

7. The apparatus for machining cylindrical grooves by multi-wire cutting of profiles according to claim 6, wherein the cutting wire comprises a wire body and abrasive particles bonded to the wire body.

8. The apparatus for machining cylindrical grooves by multi-wire cutting of profiles according to claim 7, wherein a cross-section shape of the cutting wire is consistent with a cross-section shape of a groove machined by the workpiece.

9. The apparatus for machining cylindrical grooves by multi-wire cutting of profiles according to claim 7, wherein a material of the wire body is metal wire or carbon fiber, and a material of the abrasive particle is diamond or silicon carbide.

10. The apparatus for machining cylindrical grooves by multi-wire cutting of profiles according to claim 7, wherein a bonding mode of the abrasive particles and the wire body is electroplating, organic bonding or vapor deposition.

11. The apparatus for machining cylindrical grooves by multi-wire cutting of profiles according to claim 8, wherein the cross-section shape of the cutting wire is trapezoidal, V-shaped, U-shaped, circular or rectangular.

12. A method for machining cylindrical grooves by multi-wire cutting of profiles, comprising:
S1. positioning and aligning a workpiece and a cutting wire and presetting a benchmark
assembling the workpiece on a clamping assembly, the cutting wire sequentially wound in annular grooves of a driving guide roller, a tension wheel and a driven guide roller, the cutting wire forming a parallel wire group mesh surface between the driving guide roller and the driven guide roller, wherein each cutting wire forming the wire group mesh surface is perpendicular to a central axis of the workpiece;
S2. adjusting a pressure of the cutting wire
by adjusting a first wedge block and a second wedge block disposed on the frame, a tension wheel moving up and down to change distances between the tension wheel and the driving guide roller and between the tension wheel and the driven guide roller to become larger or smaller, so as to realize a fine adjustment of tensioning or relaxing the cutting wire and further adjust the pressure of the cutting wire on a surface of a workpiece to be machined;
S3. machining a groove of the workpiece by the cutting wire
starting the driver, and a relative movement of the cutting wire realizing the machining of the groove of the workpiece; wherein a workpiece driver and a screw driver respectively drive a rotating movement and up-and-down movement of the workpiece; and the driving guide roller driver drives the driving guide roller to rotate, a releasing driver and a retracting driver are configured to drive a releasing wheel and a retracting wheel to rotate, so as to realize releasing and retracting of the cutting wire, the driven guide roller and the tension wheel are driven to rotate through a movement of the cutting wire and a rotation transmission of the driving guide roller, and a cutting wire speed is 0.1 m/s to 30 m/s.

13. The method for machining cylindrical grooves by multi-wire cutting of profiles according to claim 12, wherein in the S3, in order to prevent overheating of the cutting wire in a groove machining process, a coolant is added into a machining area of the workpiece, and a flow rate of the coolant is 1 L/min to 10 L/min.

14. The method for machining cylindrical grooves by multi-wire cutting of profiles according to claim 13, wherein in the S3, the coolant is an oil-based coolant or a water-based coolant.

15. The method for machining cylindrical grooves by multi-wire cutting of profiles according to claim 14, wherein in the S3, an antioxidant is added to the water-based coolant, and a mass concentration of the antioxidant is 2% to 5%.

16. The method for machining cylindrical grooves by multi-wire cutting of profiles according to claim 12, wherein in the S3, the coolant is used with a coolant circulation system, the coolant circulation system further comprises a peristaltic pump, and the coolant circulation system is configured to achieve a circulation of the coolant.

17. The method for machining cylindrical grooves by multi-wire cutting of profiles according to claim 16, wherein in the S3, the coolant circulation system further comprises a filter for filtering particles such as abrasive particles and chips falling from the cutting wire, so as to prevent particles from entering the coolant circulation system and thus entering the machining area of the workpiece.

18. The method for machining cylindrical grooves by multi-wire cutting of profiles according to claim 17, wherein in the S3, the filter further comprises a filter element capable of filtering particles with a diameter of 1 μm to 10 μm.

19. The method for machining cylindrical grooves by multi-wire cutting of profiles according to claim 12, wherein in the S1, a spacing of arrangement of the cutting wire in the wire group mesh surface is consistent with a spacing of the grooves of the workpiece to be machined;
the wire group mesh surface is fine-tuned by spatial positions of the driving guide roller and the driven guide roller, to realize an inclination of the wire group mesh surface in a vertical direction of 5° to 15°.

20. The method for machining cylindrical grooves by multi-wire cutting of profiles according to claim 12, wherein the number of the tension wheels is 1 to 2.
